(19) United States
(12) Patent Application Publication
(10) Pub. No.: US 2018/0253778 A1
(43) Pub. Date: Sep. 6, 2018

(54) INFORMATION PROCESSING SYSTEM, INFORMATION PROCESSING METHOD, AND NON-TRANSITORY COMPUTER-READABLE STORAGE MEDIUM STORING PROGRAM

(71) Applicant: Gurunavi, Inc., Chiyoda-ku (JP)

(72) Inventors: Kiyoshi NISHIZAWA, Chiyoda-ku (JP); Yuki KAMIGAWA, Chiyoda-ku (JP)

(73) Assignee: Gurunavi, Inc., Chiyoda-ku (JP)

(21) Appl. No.: 15/759,952

(22) PCT Filed: Sep. 29, 2016
(86) PCT No.: PCT/IB2016/001386

§ 371 Date: Mar. 14, 2018

(30) Foreign Application Priority Data
Oct. 13, 2015 (JP) 2015-201753

(51) Int. Cl. G06Q 30/06; G06Q 50/12; G06F 17/30

(52) U.S. Cl. CPC G06Q 30/0625; G06F 17/30882; G06F 17/30985; G06Q 50/12

(57) ABSTRACT

An information processing system includes a storage unit, a communication unit and a control unit. The storage unit stores restaurant information containing menu item information about a plurality of menu items that each of a plurality of restaurants is able to provide. The communication unit is communicable with a user terminal. When a restaurant search request using a menu item name as a search condition has been received from the user terminal, the control unit generates a restaurant information field list of restaurants, of which the menu item information contains a menu item corresponding to the menu item name, on the basis of the restaurant information. The control unit controls the communication unit such that the communication unit transmits a search result page to the user terminal, the search result page containing corresponding menu item information that shows at least one menu item corresponding to the menu item name on the restaurant information field list among the menu items that each restaurant is able to provide.

### BACKGROUND OF THE INVENTION

### 1. Field of the Invention

The invention relates to an information processing system, an information processing method and a non-transitory computer-readable storage medium storing a program, which are able to provide information about restaurants.

### 2. Description of Related Art

Conventionally, there is a restaurant information providing system that is able to search for a restaurant by using a location, a category, and the like, and provide information about a found restaurant.

For example, Japanese Patent Application Publication No. 2002-310686 (JP 2002-310686 A) describes a car navigation system. As a user inputs the desired type of meal, such as Japanese food, Chinese food and western food, the car navigation system searches for a restaurant by using a place around a current location of a vehicle and the input type of meal as search conditions, and displays a list of restaurants that match the conditions. As the user selects one of the restaurants, the car navigation system displays a list of menu items that are provided by the selected restaurant. As the user selects one menu item from among the list of menu items and specifies visit time, the car navigation system makes a reservation for the restaurant.

### SUMMARY OF THE INVENTION

However, with the technique described in JP 2002-310686 A, it is possible to search for a restaurant by using a restaurant category, such as Japanese food and Chinese food; however, in order to find a menu item that the user wants to eat from among menu items that belong to a selected category, it is required to find a desired menu item by selecting one restaurant from among a list of the found restaurants and further displaying a list of menu items.

The invention provides an information processing system, an information processing method and a non-transitory computer-readable storage medium storing a program, which are able to allow a user to easily select a restaurant by searching for a restaurant by using a menu item name in which the user is interested as a search condition and allowing the user to recognize a menu item of each restaurant, corresponding to the menu item name in a list of the search results.

An aspect of the invention provides an information processing system. The information processing system includes a storage unit, a communication unit, and a control unit. The storage unit stores restaurant information containing menu item information about a plurality of menu items that each of a plurality of restaurants is able to provide. The communication unit is communicable with a user terminal. When a restaurant search request using a menu item name as a search condition has been received from the user terminal, the control unit generates a restaurant information field list of restaurants, of which the menu item information contains a menu item corresponding to the menu item name, on the basis of the restaurant information. The control unit controls the communication unit such that the communication unit transmits a search result page to the user terminal, the search result page containing corresponding menu item information that shows at least one menu item corresponding to the menu item name on the restaurant information field list among the menu items that each restaurant is able to provide.

With this configuration, as the information processing system searches for a restaurant by using a menu item name of a menu item in which a user is interested as a search condition, the information processing system displays a menu item of each restaurant, corresponding to the menu item name, in a list of restaurant information fields of the search results. Thus, it is possible to allow the user to recognize the menu item name in the list, and it is possible to allow the user to select a desired restaurant on the basis of menu item names in the list. Restaurant information fields of different restaurants are placed in the restaurant information field list. That is, when the number of the pieces of corresponding menu item information to be placed in each restaurant information field is one, the total number of restaurants corresponding to the pieces of restaurant information on the restaurant information field list coincides with the total number of the pieces of corresponding menu item information.

The control unit may set a hyperlink to a menu item list page, generated on the basis of the stored menu item information, on the corresponding menu item information.

With this configuration, the information processing system is able to allow the user recognize a menu item together with a menu item that the user mainly wants to eat at a restaurant in which the user is interested.

When a restaurant of which the menu item information contains a plurality of menu items corresponding to the menu item name set as the search condition, the control unit may place one of the plurality of menu items on a corresponding one of the restaurant information fields.

With this configuration, the information processing system is able to prevent impairment of listing due to an increase in space required to display each restaurant information field.

The control unit may determine the number of pieces of corresponding menu item information that is placed in each restaurant information field in response to an area that is set for the restaurant information field.

With this configuration, the information processing system is able to allow a plurality of pieces of corresponding menu item information to be displayed when there is an area allowance in each restaurant information field. In addition, the information processing system may determine the number of the pieces of corresponding menu item information to be placed in response to the length of each restaurant information field in a scroll direction of the search result page on the user terminal.

The storage unit may store a plurality of pieces of image data associated with each restaurant as the restaurant information for each restaurant. In this case, the control unit may place one of the plurality of pieces of image data, corresponding to the menu item name set as the search condition, in each restaurant information field.

With this configuration, the information processing system is able to allow the user to easily recognize the appearance of a menu item that the user wants to eat through an image.

When the menu item name and a keyword other than the menu item name are included as the search condition, the control unit may set a higher priority for placement of the corresponding menu item information in each restaurant information field as the number of keywords other than the menu item name reduces.

With this configuration, the information processing system is able to allow the user to preferentially browse corresponding menu item information as the importance of the menu item name set as the search condition for the user rises. The priority in placement is a display position (for example, the priority is higher toward an upper side), a font size (for example, the priority is higher as the font size increases), or the like.

Another aspect of the invention provides an information processing method. The information processing method includes: receiving a restaurant search request using a menu item name as a search condition from a user terminal; generating a restaurant information field list of restaurants, of which menu item information about a plurality of menu items that each of a plurality of restaurants is able to provide contains a menu item corresponding to the menu item name, on the basis of restaurant information containing the menu item information; and transmitting a search result page to the user terminal, the search result page containing corresponding menu item information that shows at least one menu item corresponding to the menu item name on the restaurant information field list among the menu items that each restaurant is able to provide.

Further another aspect of the invention provides a non-transitory computer-readable storage medium storing a program, the program causing an information processing system to execute instructions for: receiving a restaurant search request using a menu item name as a search condition from a user terminal; generating a restaurant information field list of restaurants, of which menu item information about a plurality of menu items that each of a plurality of restaurants is able to provide contains a menu item corresponding to the menu item name, on the basis of restaurant information containing the menu item information; and transmitting a search result page to the user terminal, the search result page containing corresponding menu item information that shows at least one menu item corresponding to the menu item name on the restaurant information field list among the menu items that each restaurant is able to provide.

As described above, according to the aspects of the invention, it is possible to allow a user to easily select a restaurant by searching for a restaurant by using a menu item name in which the user is interested as a search condition and then causing the user to recognize a menu item of each restaurant, corresponding to the menu item name in a list of the search results. However, the advantageous effect does not limit the invention.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view that shows the configuration of a restaurant information providing system according to an embodiment of the invention;

FIG. 2 is a view that shows the hardware configuration of a restaurant information providing server according to the embodiment of the invention;

FIG. 3 is a view that shows the configuration of databases included in the restaurant information providing server according to the embodiment of the invention;

FIG. 4 is a flowchart that shows the flow of restaurant information providing process that is executed by the restaurant information providing server according to the embodiment of the invention; and

FIG. 5 is a view that shows an example of a restaurant search result page that is displayed on a user terminal in the embodiment of the invention.

### DETAILED DESCRIPTION OF EMBODIMENTS

Hereinafter, an embodiment of the invention will be described with reference to the accompanying drawings.

### Configuration of System

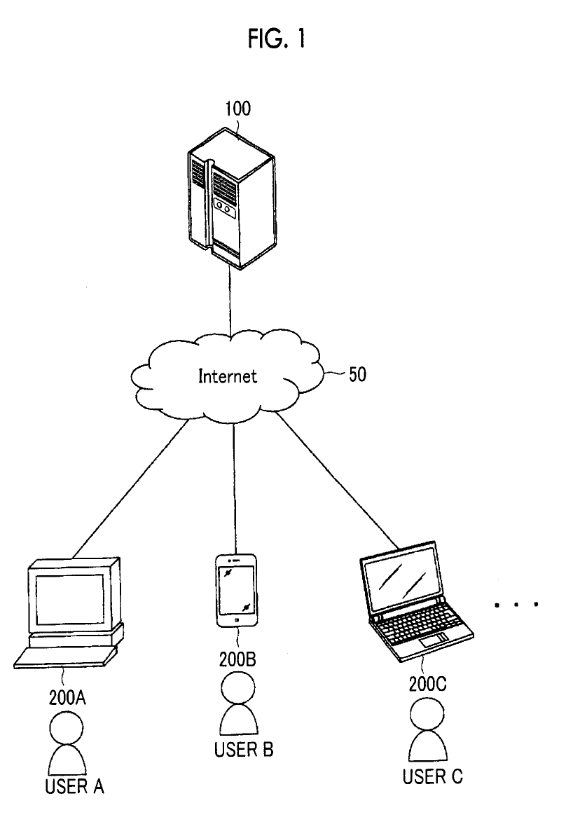

FIG. 1 is a view that shows the configuration of a restaurant information providing system according to the present embodiment.

As shown in FIG. 1, the system includes a restaurant information providing server 100 on the Internet 50, and a plurality of user terminals 200.

The restaurant information providing server 100 is a web server that manages a portal site that provides information about restaurants. The restaurant information providing server 100 is connected to the plurality of user terminals 200 via the Internet 50.

The restaurant information providing server 100 provides a restaurant information search system intended for users of the user terminals 200 on the portal site. Specifically, the restaurant information providing server 100 searches for restaurant information that matches a search condition on the basis of a search request from the user terminal 200, generates a webpage that contains search results, and transmits the webpage to the user terminal 200.

The user terminals 200 (200A, 200B, 200C, . . . ) are terminals that are used by users. Each of the user terminals 200 is, for example, a smartphone, a cellular phone, a tablet personal computer (PC), a notebook PC, a desktop PC, or the like. Each user terminal 200 accesses the restaurant information providing server 100, receives the webpage and displays the webpage on a screen by the use of a browser, or the like.

Each user terminal 200 determines a search condition for searching for a restaurant on the basis of user's operation, and transmits a restaurant search request based on the search condition to the restaurant information providing server 100. In the present embodiment, it is possible to transmit a search request when the user of the user terminal 200 selects a preset search condition, such as the location (nearest station) and category of a restaurant, and it is also possible to transmit a search request when the user inputs a free word as a search condition. The free word may be, for example, the location, the category or a restaurant name or may be a menu item name. In the following description, the case where a menu item name is a free word as a search condition will be described.

### Hardware Configuration of Restaurant Information Providing Server

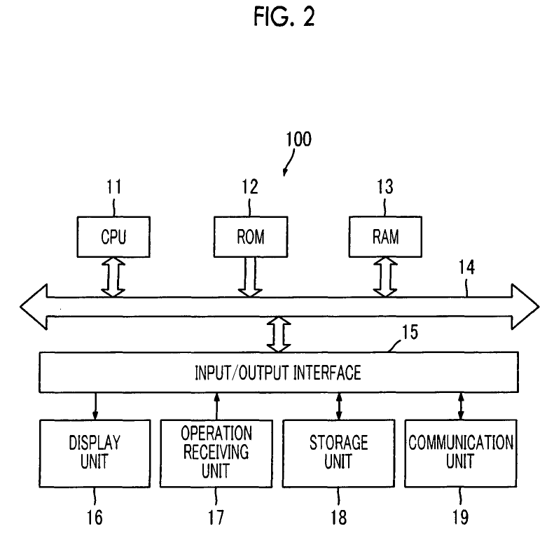

FIG. 2 is a view that shows the hardware configuration of the restaurant information providing server 100. As shown in FIG. 2, the restaurant information providing server 100 includes a central processing unit (CPU) 11, a read only memory (ROM) 12, a random access memory (RAM) 13, an input/output interface 15, and a bus 14 that connects these devices with each other.

The CPU 11 where necessary accesses the RAM 13, and the like, and generally controls all the blocks of the restaurant information providing server 100 while executing various arithmetic processing. The ROM 12 is a nonvolatile memory in which firmware, such as an OS, programs and various parameters to be executed by the CPU 11, is fixedly stored. The RAM 13 is used as a work area, or the like, of the CPU 11, and temporarily holds the OS, various active applications and various in-process data.

A display unit 16, an operation receiving unit 17, a storage unit 18, a communication unit 19, and the like, are connected to the input/output interface 15.

The display unit 16 is, for example, a display device, such as a liquid crystal display (LCD), an organic electroluminescence display (OELD) and a cathode ray tube (CRT).

The operation receiving unit 17 is, for example, a pointing device, such as a mouse, a keyboard, a touch panel, or another input device. When the operation receiving unit 17 is a touch panel, the touch panel may be integrated with the display unit 16.

The storage unit 18 is, for example, a nonvolatile memory, such as a hard disk drive (HDD), a flash memory (solid state drive (SSD)) and another solid-state memory. The OS, various applications and various data are stored in the storage unit 18.

As will be described later, particularly, in the present embodiment, the storage unit 18 includes a restaurant information database, a user information database and a menu item corresponding information database.

The communication unit 19 is, for example, a network interface card (NIC) for Ethernet or various modules for wireless communication, such as wireless LAN, and carries out communication process with the user terminals 200.

Although not shown in the drawing, the basic hardware configuration of each user terminal 200 is also substantially similar to the hardware configuration of the restaurant information providing server 100.

### Database Configuration of Restaurant Information Providing Server

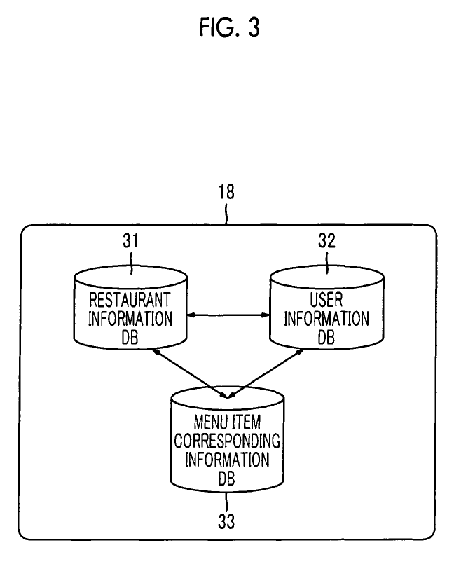

FIG. 3 is a view that shows the configuration of databases included in the restaurant information providing server 100.

As shown in FIG. 3, the restaurant information providing server 100 includes the restaurant information database 31, the user information database 32 and the menu item corresponding information database 33 in the storage unit 18.

The restaurant information database 31 stores not only the name of a restaurant, the location information of the restaurant and an ID (shop ID) that identifies the restaurant but also category information about the business category and service of the restaurant, a content that introduces the restaurant, that is, information that indicates the feature of the restaurant, such as the advertising text of the restaurant, event information about the restaurant, area information in which the restaurant is located, the address and phone number of the restaurant, image data about the restaurant (that introduce the restaurant), menu item information about menu items that the restaurant provides, information, such as business hours and the website URL, for each restaurant.

The menu item information is information corresponding to menu items that are contained in the site of each restaurant on the portal site, and stores menu item names of a plurality of menu items that each restaurant is able to provide for each restaurant. The menu item information may be, for example, stored for each menu item category, such as appetizer/main, and lunch/dinner/course. When the image data correspond to menu items, each piece of the image data is stored in association with a corresponding one of the pieces of menu item information.

The area information is stored, for example, by prefectures, and may be stored by the unit of a narrower range, for example, by municipalities. The category information, for example, may include not only main categories, such as Japanese food, Chinese food, Italian food, French food and grilled meat, but also more detailed sub-categories, such as yakitori and tempura in Japanese food and pasta and pizza in Italian food.

The user information database 32 stores information about users that respectively have the user terminals 200 and that are users (members) of a restaurant information service through the portal site that the restaurant information providing server 100 provides. Specifically, the user information database 32 stores information, such as user ID, password, name, mail address, phone number, address, age (age bracket), sex, and date of birth, for each user.

The menu item corresponding information database 33 stores a fuzzy search rule, such as notation variability, a synonym, an expression in different name, and a common typographic error, for each menu item name contained in the menu item information.

These databases are consulted with one another where necessary in a restaurant information providing process that is executed by the restaurant information providing server 100 (described later). Particularly, when there is a restaurant search request using a free word from the user terminal 200, the menu item corresponding information database 33 is also consulted together with the menu item information in the restaurant information database 31.

### Operation of Restaurant Information Providing Server

Next, the operation of the thus configured restaurant information providing server 100 will be described. The operation is executed in cooperation between hardware, such as the CPU 11 and communication unit 19 of the restaurant information providing server 100, and software stored in the storage unit 18. In the following description, for the sake of convenience, the CPU 11 executes the operation.

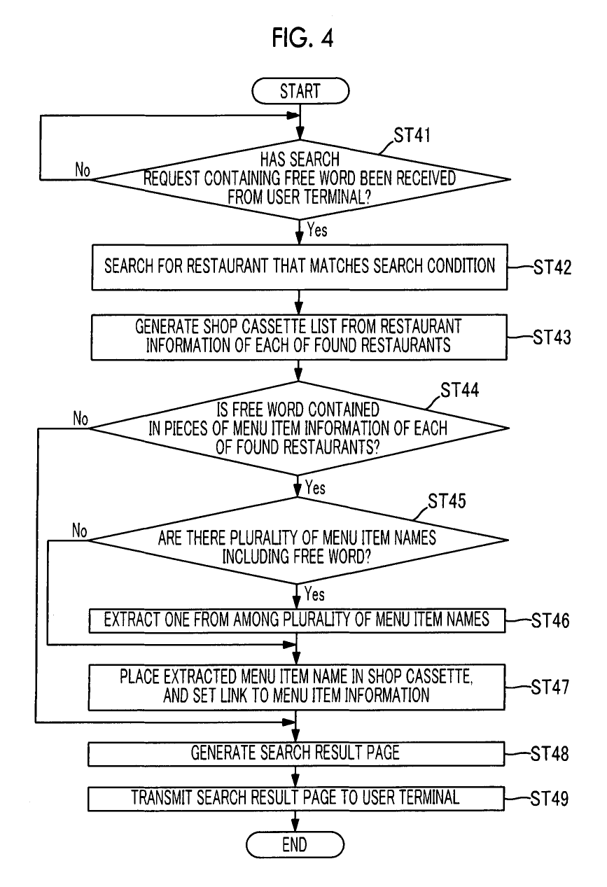

FIG. 4 is a flowchart that shows the flow of restaurant information providing process that is executed by the restaurant information providing server 100.

As shown in FIG. 4, the CPU 11 of the restaurant information providing server 100 initially determines whether a restaurant search request containing a free word as a search condition has been received from the user terminal 200 (step 41).

When it is determined that a search request containing a free word as a search condition has been received (Yes), the CPU 11 searches the restaurant information database 31 for a restaurant that matches the search condition (step 42).

Subsequently, the CPU 11 extracts the restaurant information of each restaurant that matches the search condition from the restaurant information database 31, and generates a list of restaurant information fields (shop cassettes) on the basis of the restaurant information (step 43).

Subsequently, the CPU 11 determines whether the free word set as the search condition is included in the pieces of menu item information (a list of menu item names) in each of the extracted pieces of restaurant information (step 44).

When it is determined that the free word is not included in the pieces of menu item information in each of the extracted pieces of restaurant information (No), the generated list of shop cassettes is transmitted as a search result page to the user terminal 200 that has transmitted the search request (step 48).

On the other hand, when it is determined that the free word is included in the pieces of menu item information in each of the extracted pieces of restaurant information (Yes), the CPU 11 determines whether a plurality of menu item names including the free word are included in the pieces of menu item information of each of the extracted pieces of restaurant information (step 45).

When it is determined that a plurality of menu item names including the free word are included in the pieces of menu item information (Yes), the CPU 11 extracts one from among the plurality of menu item names (step 46). As the extraction technique, for example, from among a list of the pieces of menu item information of each restaurant, a menu item name that is placed at the uppermost position among the plurality of menu item names may be extracted or a menu item name may be extracted randomly.

When one menu item name has been extracted from among the plurality of menu item names in step 46 or when there is only one menu item name including the free word in step 45 (No), the CPU 11 places the one menu item name in a shop cassette as corresponding menu item information corresponding to the free word and then sets a hyperlink to menu item list information of the restaurant corresponding to the shop cassette on the menu item name (step 47).

The processes of step 44 to step 47 are executed for each of the restaurants corresponding to the shop cassettes.

The CPU 11 generates a shop cassette list containing the corresponding menu item information as a restaurant search result page (step 48), and transmits the shop cassette list to the user terminal 200 that has transmitted the search request (step 49).

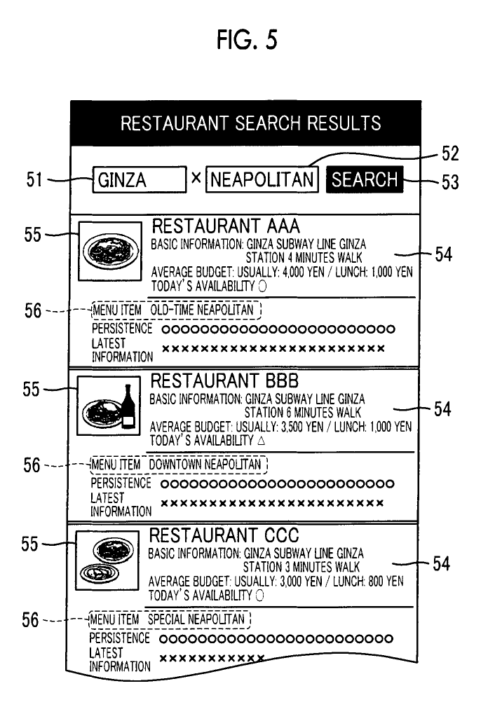

FIG. 5 is a view that shows an example of the restaurant search result page that is generated by the restaurant information providing server 100 and displayed on the display unit of each user terminal 200. FIG. 5 is an example of display in the case where the user terminal 200 is a smartphone. When the user terminal 200 is a notebook PC or a tablet PC, a display mode also varies depending on the size of the display unit.

As shown in FIG. 5, the restaurant search result page contains a list of shop cassettes 54 for respective found restaurants. Only one shop cassette 54 is provided in correspondence with one restaurant. A plurality of shop cassettes 54 are not provided in correspondence with the same restaurant. An area/station name input box 51, a free word input box 52 and a search button 53 are provided on, for example, the upper side of the list of the shop cassettes 54.

These input boxes and search button 53 are also displayed on a search request page (not shown) at the time when the user terminal 200 transmits a search request to the restaurant information providing server 100, and are reflected directly onto the search result page. FIG. 5 shows an example of the search result page in the case where “Ginza” is input to the area/station name input box 51 on the search request page, “Neapolitan” is input to the free word input box 52 and then the search request has been transmitted by depressing the search button 53.

Each shop cassette 54 contains not only basic information, such as restaurant name, access information to a restaurant, average budget information and same-day seat availability information, and a restaurant introduction image 55 but also corresponding menu item information 56 containing the free word input to the free word input box 52.

The corresponding menu item information 56 is extracted from among the pieces of menu item information of the restaurant information of each restaurant as described above. For example, when “Neapolitan” is input as a free word, the corresponding menu item information of each restaurant, that is, “Old-time Neapolitan”, “Downtown Neapolitan” or “Special Neapolitan”, including the “Neapolitan”, is extracted and displayed as the corresponding menu item information 56.

As described above, in the present embodiment, the number of the pieces of corresponding menu item information 56 is only one for each shop cassette 54. Therefore, in the list of the shop cassettes 54, the total number of the (restaurants corresponding to the) shop cassettes 54 coincides with the total number of the pieces of corresponding menu item information 56, which are respectively placed in the shop cassettes 54. That is, a list of the shop cassettes 54 is generated in the case where a menu item name is included in a search condition; however, the list of the shop cassettes 54 is absolutely displayed as a restaurant search result page. Even if a plurality of menu items including a menu item name input as the free word are included in the pieces of menu item information of one restaurant, a plurality of shop cassettes 54 of the same restaurant are not generated in correspondence with the plurality of menu items. Therefore, each user is allowed to select a restaurant where the user wants to go (in which the user is interested) while consulting the corresponding menu item information 56 by browsing the list of the shop cassettes 54.

As described above, the corresponding menu item information 56 contains a hyperlink to a menu item information page of the restaurant information of each restaurant. Therefore, when the user terminal 200 is clicked or tapped on the corresponding menu item information 56 within the shop cassette, the page shifts to the menu item information page of the restaurant corresponding to the shop cassette.

A hyperlink to the top page of the restaurant information of each restaurant is set on each restaurant name within the corresponding shop cassette. When the user terminal 200 is clicked or tapped on the restaurant name, the page shifts to the top page of the corresponding restaurant.

The CPU 11 of the restaurant information providing server 100 may extract and place an image specified by each restaurant as an image having a higher priority or an image selected randomly as the restaurant introduction image 55 from among, for example, the plurality of images stored in the restaurant information database 31. Instead, when there is an image corresponding to a menu item name included in the free word, the CPU 11 may extract and place the image. Therefore, in this case, even when a restaurant that is placed on a search result page is the same, the restaurant introduction image 55 can be different when a menu item name included in the free word is different. Thus, the restaurant information providing server 100 is able to allow the user of the user terminal 200 to visually recognize a menu item that the user wants to eat (in which the user is interested) together with the corresponding menu item information 56.

When a menu item name as the free word and another keyword (for example, area name, genre, or another free word) are included as the search condition, the CPU 11 may set a higher priority for placement of the corresponding menu item information 56 in each shop cassette 54 as the number of keywords other than the menu item name reduces.

That is, as the number of keywords other than the menu item name reduces, it is estimated that importance of (degree of interest in) the menu item name is higher for the user of the user terminal 200. In such a case, the CPU 11 places the corresponding menu item information 56 in the shop cassette 54 such that the corresponding menu item information 56 is easily recognized by the user (conspicuous to the user). In contrast, as the number of keywords other than the menu item name increases, the degree of interest in the menu item name for the user becomes relatively lower. For this reason, the CPU 11 displays the corresponding menu item information 56 within the shop cassette 54; however, the CPU 11 does not need to place the corresponding menu item information 56 such that the corresponding menu item information 56 is more conspicuous to the user than another piece of information.

For example, as the number of keywords other than the menu item name reduces, the CPU 11 may set the position of the corresponding menu item information 56 to an upper position within the shop cassette 54, or increases the font size of the corresponding menu item information 56, or may thicken the font of the corresponding menu item information 56.

### Conclusion

As described above, according to the present embodiment, in the restaurant information providing server 100, as a user issues a request to search for a restaurant by using the menu item name of an interested menu item as a search condition, the corresponding menu item information of each restaurant, corresponding to the menu item name, is displayed in a list of the shop cassettes 54 of the search result page. Thus, it is possible to allow the user to recognize the menu item name through the list of the shop cassettes 54, and it is possible to cause the user to select a desired restaurant on the basis of menu item names in the list. In addition, it is possible to cause the user to select a desired restaurant that provides a desired menu item in one step unlike the existing technique for causing a user to select a restaurant from among a list of found restaurants and then find a desired menu item by displaying a list of menu items (two steps), so the load on the restaurant information providing server 100 is reduced. Also, because the amount of the data needs to be displayed by the user terminal 200 is decreased due to the search result being decreased, the amount of data needs transmitting decreases.

### Alternative Embodiments

The invention is not limited to the above-described embodiment. The above-described embodiment may be variously modified without departing from the scope of the disclosure.

In the above-described embodiment, when a plurality of menu item names (pieces of corresponding menu item information) corresponding to the free word have been found from among the pieces of menu item information of each restaurant, only one of the menu item name is extracted and placed. Instead, a plurality of pieces of corresponding menu item information may be placed. In this case, the CPU 11 of the restaurant information providing server 100 may determine the number of the pieces of corresponding menu item information in response to the area that is set for each shop cassette 54.

Alternatively, the CPU 11 may determine the number of pieces of corresponding menu item information in response to the length of each shop cassette 54 in a scroll direction of the search result page on the user terminal 200. The length of the shop cassette 54 may be determined on the basis of the number of found restaurants that match the search condition. Therefore, for example, when the number of found restaurants is relatively small, the area of each shop cassette 54 or the length of each shop cassette 54 in the scroll direction is also relatively larger, and space arises by that much, so the number of pieces of corresponding menu item information to be placed may also increase accordingly.

In the above-described embodiment, at the time when the user terminal 200 transmits a restaurant search request to the restaurant information providing server 100, a search request using various free words including a restaurant name or a menu item name is transmitted, and the restaurant information providing server 100 searches all the pieces of restaurant information in the restaurant information database 31 as a search target for a restaurant that matches the free word. Instead, the free word limited to a menu item name may be allowed to be input. In this case, the restaurant information providing server 100 searches only the menu item information in the restaurant information database 31 as a search target for the input menu item name. For this reason, the load on the restaurant information providing server 100 is reduced.

In the above-described embodiment, in each shop cassette of a search result page, corresponding menu item information is placed as a menu item name (text information). Instead, the corresponding menu item information may be placed as an image (photo) instead of text information. This image is an image stored as the menu item information in the restaurant information database 31 in association with the menu item name. In this case, the restaurant introduction image 55 may be placed in the shop cassette 54 in addition to an image as the corresponding menu item information or the restaurant introduction image 55 does not need to be placed.

1 -10. (canceled)

11. An information processing system comprising:
a storage circuity that stores restaurant information containing menu item information about a plurality of menu items that each of a plurality of restaurants is able to provide;
a communication circuity that is communicable with a user terminal; and
a control circuity that, when a restaurant search request using a menu item name as a search condition has been received from the user terminal, generates a restaurant information field list of restaurants, of which the menu item information contains a menu item corresponding to the menu item name, on the basis of the restaurant information, and that controls the communication circuity such that the communication circuity transmits a search result page to the user terminal, the search result page containing corresponding menu item information that shows at least one menu item corresponding to the menu item name on the restaurant information field list among the menu items that each restaurant is able to provide
wherein when a restaurant of which the menu item information contains a plurality of menu items corresponding to the menu item name set as the search condition has been found, the control circuity places one of the plurality of menu items on a corresponding one of the restaurant information fields.

12. The information processing system according to claim 11, wherein
the control circuity sets a hyperlink to a menu item list page, generated on the basis of the stored menu item information, on the corresponding menu item information.

13. The information processing system according to claim 11, wherein
the control circuity determines the number of pieces of corresponding menu item information that is placed in each restaurant information field in response to an area that is set for the restaurant information field.

14. The information processing system according to claim 11, wherein
the control circuity determines the number of pieces of corresponding menu item information that is placed in each restaurant information field in response to the length of each restaurant information field in a scroll direction of the search result page on the user terminal.

15. The information processing system according to claim 11, wherein
the control circuity determines the length of each restaurant information field in a scroll direction of the search result page on the user terminal in response to the number of pieces of corresponding menu item information that is placed in the restaurant information field.

16. The information processing system according to claim 11, wherein
the storage circuity stores a plurality of pieces of image data associated with each restaurant as the restaurant information for each restaurant, and
the control circuity places one of the plurality of pieces of image data, corresponding to the menu item name set as the search condition, in each restaurant information field.

17. The information processing system according to claim 11, wherein
when the menu item name and a keyword other than the menu item name are included as the search condition, the control circuity sets a higher priority for placement of the corresponding menu item information in each restaurant information field as the number of keywords other than the menu item name reduces.

18. An information processing method comprising:
receiving a restaurant search request using a menu item name as a search condition from a user terminal;
generating a restaurant information field list of restaurants, of which menu item information about a plurality of menu items that each of a plurality of restaurants is able to provide contains a menu item corresponding to the menu item name, on the basis of restaurant information containing the menu item information; and
transmitting a search result page to the user terminal, the search result page containing corresponding menu item information that shows at least one menu item corresponding to the menu item name on the restaurant information field list among the menu items that each restaurant is able to provide
wherein, when a restaurant of which the menu item information contains a plurality of menu items corresponding to the menu item name set as the search condition has been found, one of the plurality of menu items is placed on a corresponding one of the restaurant information fields.

19. A non-transitory computer-readable storage medium storing a program, the program causing an information processing system to execute instructions for:
receiving a restaurant search request using a menu item name as a search condition from a user terminal;
generating a restaurant information field list of restaurants, of which menu item information about a plurality of menu items that each of a plurality of restaurants is able to provide contains a menu item corresponding to the menu item name, on the basis of restaurant information containing the menu item information; and
transmitting a search result page to the user terminal, the search result page containing corresponding menu item information that shows at least one menu item corresponding to the menu item name on the restaurant information field list among the menu items that each restaurant is able to provide
wherein, when a restaurant of which the menu item information contains a plurality of menu items corresponding to the menu item name set as the search condition has been found, one of the plurality of menu items is placed on a corresponding one of the restaurant information fields.
